(19) United States
(12) Patent Application Publication
(10) Pub. No.: US 2012/0088458 A1
(43) Pub. Date: Apr. 12, 2012

(54) TRANSMISSION DEVICE, RECEIVING DEVICE, COMMUNICATION SYSTEM, AND COMMUNICATION METHOD

(76) Inventors: Toshizo Nogami, Osaka (JP); Kazuyuki Shimezawa, Osaka (JP); Shoichi Suzuki, Osaka (JP); Yosuke Akimoto, Osaka (JP)

(21) Appl. No.: 13/378,311

(22) PCT Filed: May 26, 2010
(86) PCT No.: PCT/JP2010/003526

§ 371 Date: Dec. 14, 2011

(30) Foreign Application Priority Data
Jun. 19, 2009 (JP) 2009-146081

(51) Int. Cl. H04B 17/00

(52) U.S. Cl. 455/67.11

(57) ABSTRACT

A transmission device includes: a transmitting unit that transmits a common reference signal and a receiving device-specific reference signal to a receiving device; a selecting unit that selects either a first mode reporting a receiving quality using only the common reference signal or a second mode reporting a receiving quality using at least the receiving device-specific reference signal; and a notifying unit that notifies a mode selected by the selecting unit to the receiving device.

### TECHNICAL FIELD

The present invention relates to a transmission device, a receiving device, a communication system, and a communication method.

The present application claims priority based on the patent application 2009-146081, filed on Jun. 19, 2009 in Japan, the content of which is incorporated herein by reference.

### BACKGROUND ART

In mobile wireless communication systems including such as WCDMA (wideband code-division multiple access), LTE (Long Term Evolution), LTE-A (LTE-Advanced) and WiMAX (Worldwide Interoperability for Microwave Access), in accordance with 3GPP (Third Generation Partnership Project), an area that is covered by a base station (base station apparatus, transmitting station, transmission device, eNodeB) or a transmitting station that is in accordance with a base station has a cellular configuration in which a plurality of cells are disposed, thereby expanding the communication area.

By using different frequencies between adjacent cells or between adjacent sectors, even for terminal devices (receiving devices, receiving stations, mobile stations, mobile terminals, UE (User Equipment)) that are positioned in a cell edge region or a sector edge region, it is possible to perform communication without interference from the transmitted signals from a plurality of base stations. There is, however, the problem of a poor rate of frequency spectrum utilization. In reverse, by using the same frequency between adjacent cells or sectors, it is possible to improve the rate of frequency spectrum utilization. Interference countermeasures are, however, necessary to handle interference to terminal devices being in a cell edge region.

By performing adaptive control of the modulation method, the coding scheme (MCS: Modulation and Coding Scheme), the degree of the spatial multiplexing (layers and ranks) and precoding weight (precoding matrix) in accordance with the condition of the transmission path between a base station and a terminal device, data transfer is achieved with improved efficiency. Non-Patent Document 1 discloses a method that applies these types of control.

FIG. 14 is a drawing showing a base station 1401 and a terminal device 1402 that perform MIMO (multiple-input multiple-output) transmission in LTE-A. A proposal is made of the terminal device 1402 in LTE-A using a common reference signal transmitted from the base station 1401, (that is, a propagation channel condition measurement reference signal, the CSI-RS (channel state information RS), and unprecoded RS), to transmit feedback information to the base station 1401. The CSI-RS is transmitted to the terminal device 1402 from the base station 1401. The terminal device 1402 transmits feedback information generated based on the CSI-RS to the base station 1401. In the case of the downlink used for data transfer from the base station 1401 to the terminal device 1402, in order to perform the above-noted adaptive control, the downlink transmission path condition or the like is estimated at the terminal device 1402 based on the CSI-RS transmitted from the base station 1401.

Then, estimated transmission path condition or the like is transmitted (fed back) to the base station 1401 via the uplink that performs data transfer by the terminal device 1402 to the base station 1401. Non-Patent Document 2 proposes the placement of a CSI-RS in only some of the subframes as shown in FIG. 15, rather than locating the CSI-RS in all subframes on the time axis when locating the CSI-RSs. The wireless frame 1500 in FIG. 15 includes a subframe 1500-2 in which the CSI-RS is placed, and a subframe 1500-1 in which the CSI-RS is not placed.

FIG. 16 is a drawing showing an example of a reference signal transmitted by the base station 1401. In FIG. 16, the horizontal axis indicates time and the vertical axis indicates frequency. The various square regions within a resource block (RB) 1601 that is defined by a prescribed time and frequency indicate resource elements (REs, that is, the regions in which the modulating symbol is mapped). The reference numerals 1601-1 to 1601-4 indicate resource elements onto which the LTE-A reference signals are mapped. The reference numeral 1601-5 indicates the resource element onto which an LTE reference signal is mapped. The reference numeral 1601-6 indicates a resource element onto which a signal other than a reference signal (that is, a data signal, control signal, or the like) is mapped.

As the position of the reference signal, it is possible to use a reference signal scattered among the resource elements in the frequency direction and the time direction. The UE in the LTE-A can use information that indicates the channel characteristics (CSI: Channel State Information), the recommended transmission format information with respect to the base station (CQI: Channel Quality Indicator), the RI (Rank Indicator), PMI (Precoding Matrix Index), or the like as the information (feedback information), which is generated based on this LTE-A reference signal and feedbacks to the base station. On the contrary, there is a proposal for a user-specific reference signal for using demodulation (a demodulation reference signal, DM-RS) to insert for each user, separate from the CSI-RS.

### PRIOR ART DOCUMENTS

### Non-Patent Documents

Non-Patent Document 1: 3rd General Partnership Project; Technical Specification Group Radio Access Network; Evolved Universal Terrestrial Radio Access (E-UTRA); Physical Layer Procedures (Release 8), December 2008, 3GPP TS 36.213 V8.5.0 (2008 December)
Non-Patent Document 2: 3GPP-TSG RAN WG1 #56-bis, R1-091351, “CSI-RS design for LTE-Advanced downlink”, March 2009

### DISCLOSURE OF INVENTION

### Problem to be Solved by the Invention

In conventional communication schemes, however, when the common reference signal overhead is to be reduced, a density of the common reference signal that can be referenced is reduced, so that it is difficult to acquire the appropriate feedback information, this hindering improvement of the transmission efficiency.

The present invention was made in consideration of the above-noted problems, and has as an object to provide a transmission device, a receiving device, a communication system, and a communication method that enable efficient acquisition of feedback information that uses a common reference signal and a user-specific reference signal.

### Means for Solving the Problem

(1) The present invention has been made to solve the above-described problems, and a first aspect of the present invention is a transmission device including: a transmitting unit that transmits a common reference signal and a receiving device-specific reference signal to a receiving device; a selecting unit that selects either a first mode reporting a receiving quality using only the common reference signal or a second mode reporting a receiving quality using at least the receiving device-specific reference signal; and a notifying unit that notifies a mode selected by the selecting unit to the receiving device.

(2) In the transmission device according to the first aspect of the present invention, the second mode may report a receiving quality using the common reference signal and the receiving device-specific reference signal.

(3) In the transmission device according to the first aspect of the present invention, the second mode may report a receiving quality in a part of the frequency band in which transmission is possible.

(4) In the transmission device according to the first aspect of the present invention, the second mode may be a mode that reports a receiving quality in both all and a part of the frequency band in which transmission is possible.

(5) In the transmission device according to the first aspect of the present invention, the second mode may be a mode that reports a receiving quality with a higher frequency of occurrence than that of the first mode.

(6) A second aspect of the present invention is a receiving device including: a receiving unit that receives a common reference signal and a receiving device-specific reference signal transmitted from the transmission device; and a reporting unit that reports to the transmission device a receiving quality using at least the receiving device-specific reference signal.

(7) A third aspect of the present invention is a receiving device including: a receiving unit that receives a common reference signal and a receiving device-specific reference signal transmitted from the transmission device; and a reporting unit that switches between reporting to the transmission device a receiving quality using only the common reference signal and a report thereto a receiving quality using at least the receiving device-specific reference signal.

(8) A fourth aspect of the present invention is a receiving device including: a receiving unit that receives a common reference signal and a receiving device-specific reference signal transmitted from the transmission device; an acquiring unit that acquires from the transmission device either a first mode that reports the receiving quality using only the common reference signal, or a second mode that reports the receiving quality using at least the receiving device-specific reference signal; and a reporting unit that, if the mode acquired by the acquiring unit is the first mode, reports to the transmission device the receiving quality using only the common reference signal, and that, if the mode acquired by the acquiring unit is the second mode, reports to the transmission device the receiving quality using at least the receiving device-specific reference signal.

(9) A fifth aspect of the present invention is a communication system including a transmission device and a receiving device, wherein the transmission device includes: a transmitting unit that transmits a common reference signal and a receiving device-specific reference signal; a selecting unit that selects either a first mode that reports the receiving quality using only the common reference signal, or a second mode that reports the receiving quality using at least the receiving device-specific reference signal; and a notification unit that notifies a mode selected by the selecting unit to the receiving device; and wherein the receiving device includes: an acquiring unit that acquires the mode selected by the transmission device; and a reporting unit that, if the mode acquired by the acquiring unit is the first mode, reports to the transmission device the receiving quality using only the common reference signal, and that, if the mode acquired by the acquiring unit is the second mode, reports to the transmission device the receiving quality using at least the receiving device-specific reference signal.

(10) A sixth aspect of the present invention is a communication method including: transmitting a common reference signal and a receiving device-specific reference signal to a receiving device; selecting either a first mode that reports the receiving quality using only the common reference signal, or a second mode that reports the receiving quality using at least the receiving device-specific reference signal; and notifying the selected mode to the receiving device.

(11) A seventh aspect of the present invention is a communication method including: receiving a common reference signal and a receiving device-specific reference signal transmitted from a transmission device; and reporting a receiving quality to the transmission device using at least the receiving device-specific reference signal.

### Effects of the Invention

According to the present invention, it is possible to efficiently acquire feedback information that uses a common reference signal and a user-specific reference signal.

### BRIEF DESCRIPTION OF THE DRAWINGS

FIG. 1 is a drawing showing an example of the configuration of a communication system according to a first embodiment of the present invention.

FIG. 2 is a drawing showing an example of the configuration of a wireless frame in the same embodiment.

FIG. 3 is a drawing showing an example of the configuration of subframes in the same embodiment.

FIG. 4A is a drawing showing an example of the configuration of a resource block in the same embodiment.

FIG. 4B is a drawing showing another example of the configuration of a resource block in the same embodiment.

FIG. 4C is a drawing showing yet another example of the configuration of a resource block in the same embodiment.

FIG. 4D is a drawing showing yet another example of the configuration of a resource block in the same embodiment.

FIG. 5 is a table showing an example of feedback modes in the same embodiment.

FIG. 6 is a sequence diagram showing an example of the processing between a base station (transmission device) and a terminal device (receiving device) in the same embodiment.

FIG. 7 is a simplified block diagram showing an example of the configuration of the base station (transmission device) in the same embodiment.

FIG. 8 is a simplified block diagram showing an example of the configuration of the terminal device (receiving device) in the same embodiment.

FIG. 9 is a table showing an example of feedback modes in a second embodiment of the present invention.

FIG. 10 is a sequence diagram showing an example of the processing between the base station (transmission device) and the terminal device (receiving device) in the same embodiment.

FIG. 11 is a table showing an example of feedback modes in the third embodiment of the present invention.

FIG. 12 is a sequence diagram showing an example of the processing between the base station (transmission device) and the terminal device (receiving device) in the same embodiment.

FIG. 13 is a table showing an example of feedback modes corresponding to transmission modes in a fourth embodiment of the present invention.

FIG. 14 is a drawing showing the configuration of a communication system that performs MIMO communication.

FIG. 15 is a drawing showing the configuration of a wireless frame in a communication system that performs MIMO communication.

FIG. 16 is a drawing showing the configuration of a resource block in a communication system that performs MIMO communication.

### BEST MODE FOR CARRYING OUT THE INVENTION

### First Embodiment

The first embodiment of the present invention will be described below, with references made to the drawings.

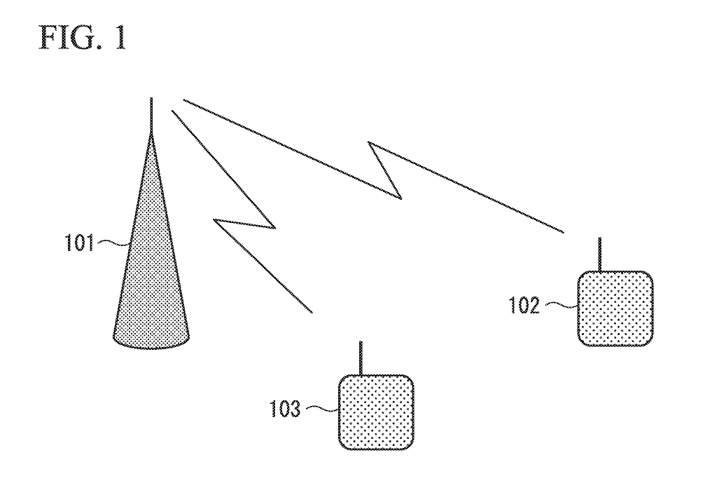

FIG. 1 is a drawing showing the general configuration of a communication system according to the first embodiment of the present invention. The communication system of FIG. 1 assumes an LTE-A system. This communication system includes a base station (transmission devices, base station apparatuses, eNodeB, eNB, cells, uplink receiving devices) 101, which constitutes the cell, and terminal devices (receiving devices, UEs, uplink transmission devices) 102 and 103. The base station 101 and the terminal devices 102 and 103 perform MIMO communication, (or single-cell communication such as SISO (single-input, single-output) communication and transmission diversity (TxD) communication).

That is, the base station 101 houses the terminal device 102 and the terminal device 103 that perform MIMO communication. Although in this case the description is presented for the case in which the base station 101 houses the terminal device 102 and the terminal device 103 at the same time, this is not a restriction. The base station 101 may house the terminal device 102 and the terminal device 103 at different times. Also, although in this case the base station is used as a transmission device that covers one cell, this is not a restriction. In the case in which cells having the number of sectors are covered using a plurality of sectors by one base station, the base station in the present embodiment is replaced by a sector. Alternatively, the transmission device may be a repeater that covers cells other than the base station. Additionally, although the description here is for a downlink, application may be done to an uplink or to an ad hoc network.

The terminal device 102 and the terminal device 103 that perform MIMO communication measure a transmission path status measurement reference signal transmitted from the base station 101, (that is, a CSI-RS (channel state information RS), an unprecoded RS, a cell-specific RS, an unique cell reference signal, a common reference signal, a unprecoded reference signal, and an SRS (sounding RS)), generates feedback information. The terminal device 102 and the terminal device 103 report the generated feedback information to the base station 101. In this case, the CSI-RS is transmitted from the base station 101 as the CSI-RS for each port (logical port, antenna port). The terminal device 102 and the terminal device 103 can measure the CSI-RS for each port.

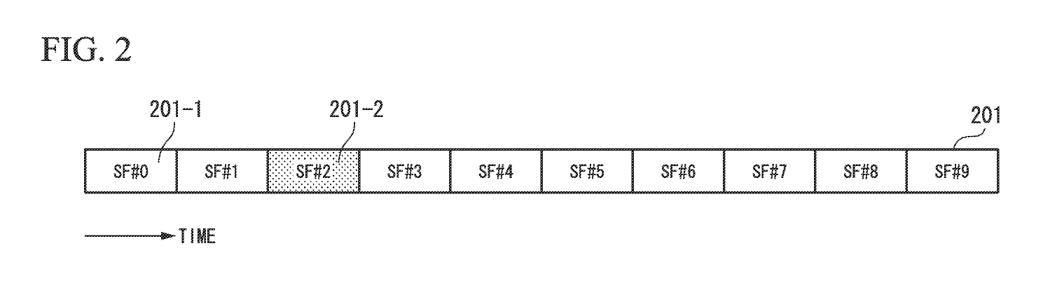

FIG. 2 is a drawing showing an example of the configurations of the wireless frames transmitted from the base station 101. In FIG. 2, the horizontal axis indicates time. The wireless frame 201 is a wireless frame transmitted from the base station 101. The wireless frame 201 includes the 10 subframes SF#0 to SF#9. The wireless frame 201 includes a subframe 201-2 in which the CSI-RS is placed and a subframe 201-1 in which the CSI-RS is not placed.

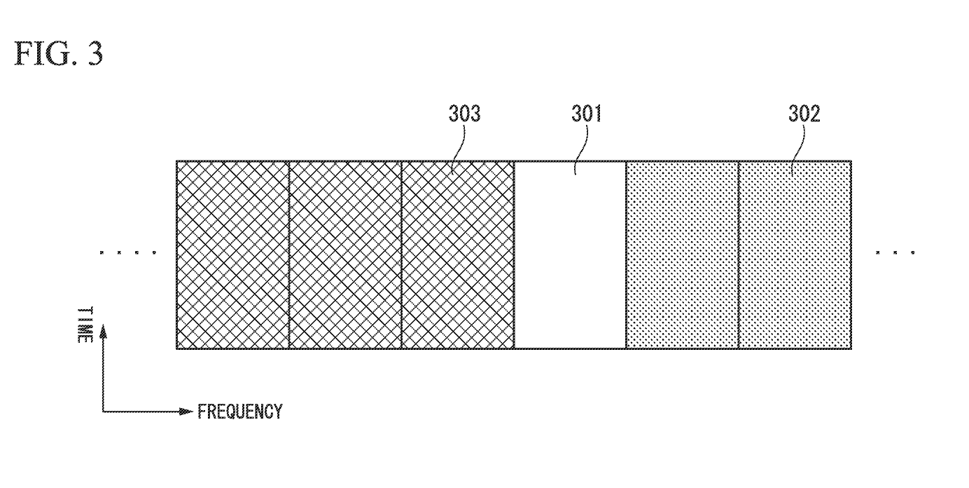

FIG. 3 is a drawing showing an example of the configuration of a subframe transmitted from the base station 101. The subframe is partitioned into a prescribed number of resource blocks (RBs) in the frequency direction, and each of the resource blocks can be allocated to the different terminal devices. The resource block 301 in FIG. 3 is a resource block that is not allocated to any terminal device. The resource block 302 is a resource block that is allocated to the terminal device 102 as well. The resource block 303 is a resource block that is allocated to the terminal device 103 as well.

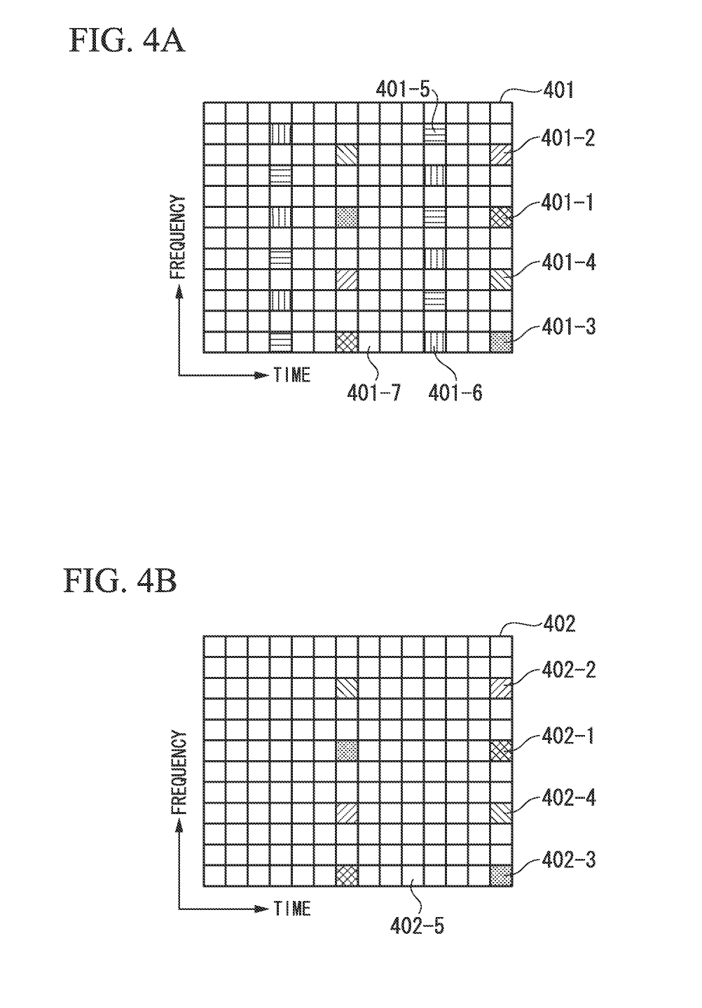

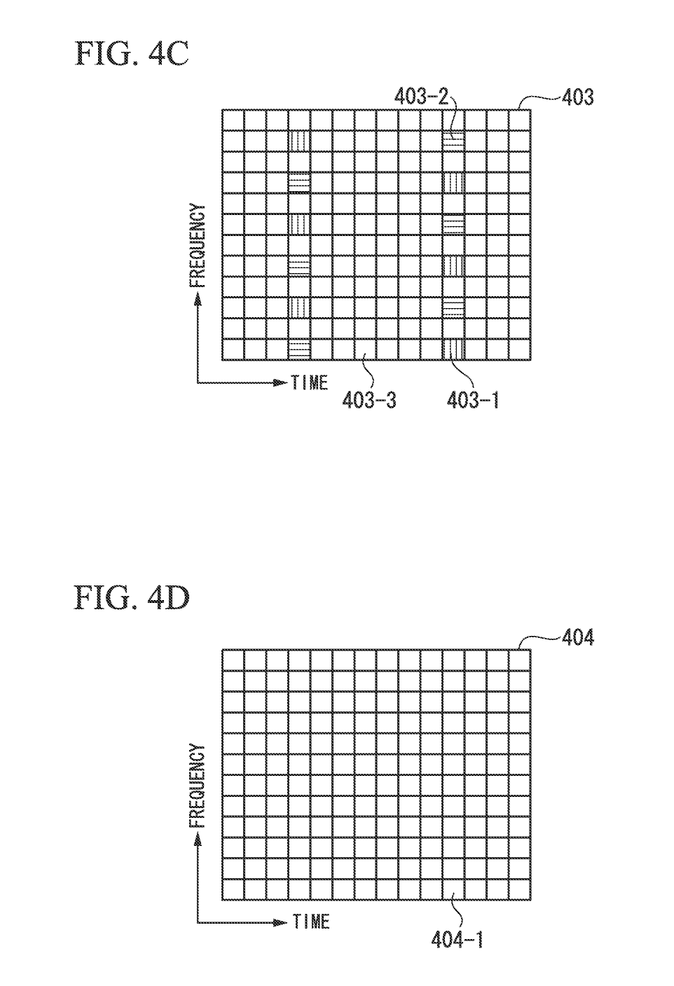

FIG. 4A to FIG. 4D is a drawing showing an example of the configuration of the CSI-RS in the resource block, the reference signal for demodulation (DM-RS (demodulation RS), precoded RS, UE-specific RS, DRS (dedicated RS), user-specific reference signals (terminal device and receiving device), and precoded reference signal). From 401 to 404 indicate each of the resource blocks. In FIG. 4A to FIG. 4D, the horizontal axis indicates time, and the vertical axis indicates frequency.

The resource blocks 401 and 402 are resource blocks into which the CSI-RS is placed. The resource block 401 shown in FIG. 4A has resource elements 401-1 to 401-4 onto which CSI-RS is mapped. The resource block 402 shown in FIG. 4B has resource elements 402-1 to 402-4 onto which CSI-RS is mapped. The resource blocks 401 and 403 are resource blocks into which DM-RS is placed. The resource block 401 has resource elements 401-5 and 401-6, onto which DM-RS is mapped. The resource block 403 shown in FIG. 4C has resource elements 403-1 and 403-2 onto which DM-RS is mapped. The resource block 404 shown in FIG. 4D has neither CSI-RS nor DM-RS. The other resource elements 401-7, 402-5, 403-3, and 404-1 indicate resource elements onto which a signal other than an LTE-A reference signal (CSI-RS and DM-RS) (a data signal, a control signal, and an LTE reference signal or the like) is mapped.

The resource elements 401-1 to 401-4 within the resource block 401 and the resource elements 402-1 to 402-4 within the resource block 402 are resource elements onto which a CSI-RS corresponding to the ports C1 to C4, which are each different ports for CSI-RS, is mapped. The resource elements 401-5 to 401-6 within the resource block 401 and the resource elements 403-1 and 403-2 within the resource block 403 are resource elements onto which a DM-RS corresponding to the ports D1 to D4, which are each different ports for DM-RS, is mapped. Port D1 to port D4 are ports that transmit data signals transmitted in resource blocks into which DM-RS is inserted.

That is, DM-RS is subjected to the same transmission processing as a data signal. However, although the case in which the CSI-RSs regarding the four ports are placed in one resource block is described, the CSI-RSs regarding an arbitrary number of ports (for example, 1, 2, 4, or 8 ports) may be placed. Also, although the case in which the DM-RSs regarding two ports are placed in one resource block is described, this is not a restriction. For example, by adjusting the number of ports for DM-RS placed within one resource block to the rank (number of layers, number of streams, degree of spatial multiplexing) of the data signals addressed to the terminal device allocated to that resource block, thereby enabling the efficient setting of the DM-RS density.

Next, the relationship between the resource blocks 401 to 404 shown in FIG. 4A to FIG. 4D, the wireless frame shown in FIG. 2, and the subframes shown in FIG. 3 will be described.

First, in the subframe 201-2 in FIG. 2, if the resource block allocation is made as shown in FIG. 3, the resource block 301, similar to the resource block 402, has a structure that has a CSI-RS, and that does not have a DM-RS. The resource block 302, similar to the resource block 401, has a structure that has a CSI-RS and also has a DM-RS for the terminal device 102. Additionally, the resource block 303, similar to the resource block 401, has a structure that has a CSI-RS and also has a DM-RS for the terminal device 103.

Next, in the subframe 201-1 in FIG. 2, if the resource block allocation is made as shown in FIG. 3, the resource block 301, similar to the resource block 404, has a structure that has neither a CSI-RS nor a DM-RS. The resource block 302, similar to the resource block 403, has a structure that does not have a CSI-RS but has a DM-RS for the terminal device 102. Additionally, the resource block 303, similar to the resource block 403, has a structure that does not have a CSI-RS but has a DM-RS for the terminal device 103.

In this case, the DM-RS for the terminal device 102 and the DM-RS for the terminal device 103 do not need to be the same stream or structure. For example, a stream that is generated using an UE-specific number (UE-ID, RNTI (Radio Network Temporary Identifier)) may be used, and the DM-RS may be placed on a subcarrier calculated using the UE-ID. The above-described number of ports for the DM-RS can be set separately for each terminal device. In contrast, it is preferable to use the same stream or structure for the CSI-RSs.

An example of the method of measurement of the receiving quality (or propagation channel condition) using the CSI-RS, which is the method of measurement performed by the terminal devices 102 and 103 shown in FIG. 1, will now be described. The terminal devices 102 and 103 that are housed in the base station 101 synthesize the received signal at the resource elements 401-1 to 401-4 or the resource elements 402-1 to 402-4, onto which the CSI-RS transmitted from the base station 101 are mapped for each port. By doing this, the terminal devices 102 and 103 generate replicas of the received signals from the base station 101. Next, the terminal devices 102 and 103 performs subtraction of the replicas from the received signals at the resource elements 401-1 to 401-4 or the resource elements 402-1 to 402-4 and averaging.

By doing this, the terminal device 102 and the terminal device 103 calculate a signal (interference signals) and electrical noise power transmitted from the base station other than the base station 101. Taking in consideration of the prescribed precoding matrix, the replica electrical power is divided by the interference signal and electrical noise power, so as to calculate the signal-to-interference-and-noise ratio (SINR). The terminal device 102 and the terminal device 103 select a CQI (Channel Quality Indicator) and an RI (Rank Indicator) so that a prescribed quality at the calculated SINR is satisfied. The terminal device 102 and the terminal device 103 also select a PMI (Precoding Matrix Index) so that the calculated SINR increases. An index that indicates the transmission rate such as the MCS for each of cord words can be used as the CQI. An index that indicates the degree of spatial multiplexing can be used as R1. An index that indicates the precoding matrix (or vector) can be used as the PMI. In this manner, by measuring the resource elements 401-1 to 401-4 or the resource element 402-1 to 402-4, the terminal device 102 and the terminal device 103 can generate feedback information that takes into consideration the interference signals and noise.

Next, another example of the method of measuring the received signal quality (or propagation channel condition) using the CSI-RS, which is the method of measurement performed by the terminal devices 102 and 103 shown in FIG. 1, will be described. By synthesizing the received signals at the resource elements 401-1 to 401-4 or the resource elements 402-1 to 402-4, onto which the CSI-RS transmitted from the base station 101 are mapped for each port, the terminal devices 102 and 103 can generate replicas of the received signals from the base station 101.

From the received signal replicas from the received signal replicas obtained from the base station 101, the terminal devices 102 and 103 generate feedback information (CSI (Channel State Information), information that indicates the channel matrix, or information for a processed channel matrix). The terminal devices 102 and 103 may generate signal replicas by subtracting the replicas of the received signals from the base station 101 from the received signals at the resource elements 401-1 to 401-4 or the resource elements 402-1 to 402-4, and may generate a CSI-RS that includes this. Notification may be made to terminal devices 102 and 103 of the CSI-RS information at a base station other than the base station 101 beforehand, and a CSI-RS replica at a base station other than the base station 101 may be calculated beforehand, with this included in the CSI.

As described above, the CSI-RS is placed in both the resource block 402, to which neither terminal device is allocated, and the resource block 401, to which a terminal device is allocated. For this reason, the terminal device can measure to cover a broad bandwidth, regardless of the allocation status of the terminal device, and not limited to the bandwidth allocated thereto.

Next, an example of the method of measurement of the receiving quality (or propagation channel condition) using the DM-RS, which is the method of measurement performed by the terminal devices 102 and 103 shown in FIG. 1, will be described. The terminal device 102 that is housed in the base station 101 synthesizes the received signal at the resource elements 401-5 and 401-6 or the resource elements 403-1 and 403-2, onto which the DM-RS is mapped within a resource block allocated to the terminal device itself for each port. By doing this, the terminal device 102 generates replicas of the received signals from the base station 101.

Next, the terminal device 102 performs subtraction of the replicas from the received signals at the resource elements 401-5 and 401-6 or the resource elements 403-1 and 403-2, and averaging. By doing this, the terminal device 102 calculates a signal (interference signal) transmitted from a base station other than the base station 101 and the electrical noise power. The terminal device 102, by dividing the replica electrical power by the electrical power of the interference signal and the noise, calculates the SINR. In this case, the CSI-RS is used for the purpose of generating replicas of received signals for each of transmitting antennas (physical ports). In contrast, because the DM-RS is used for generating replicas of received signals for each layer, it is not necessary to consider the prescribed precoding. The terminal device 102 selects a CQI or RI so that a prescribed quality at the calculated SINR is satisfied. The terminal device 102 also selects a PMI so that the calculated SINR increases.

This description was for the case in which only a DM-RS within a resource block which is allocated to the terminal device 102 itself is measured by the terminal device 102. However, in the case of acquiring the allocation information of another terminal device, information of the stream/structure/transmitting power of the DM-RS, or rank information, a resource element to which a DM-RS addressed to another terminal device is allocated may be measured. With regard to the terminal device 103 as well, by performing the same type of processing as the terminal device 102, it is possible to perform measurement of the receiving quality (or propagation channel condition) using the DM-RS.

As described above, the DM-RSs are inserted for each terminal device to which a resource block is allocated, and are placed along the time direction in a higher number than the CSI-RSs. For this reason, a terminal device, in addition to being able to measure the DM-RS with a short time period, can accommodate a feedback mode that has a short feedback period. That is, it is possible for the terminal device to make highly frequent reports to the base station. Also, because the DM-RSs for each terminal device are inserted into only resource blocks to which each terminal device is allocated, detailed measurement is possible. The DM-RS is subjected to the same precoding processing as a data signal in the resource block into which it is inserted. For this reason, by measuring the DM-RS, the terminal device can more accurately measure the receiving quality (or propagation channel condition) of the data signal. Because the DM-RS is specific to a terminal device, it is possible to perform transmitting power control with a high degree of freedom. For this reason, the terminal device can perform appropriate measurement even in an environment in which the communication conditions are poor.

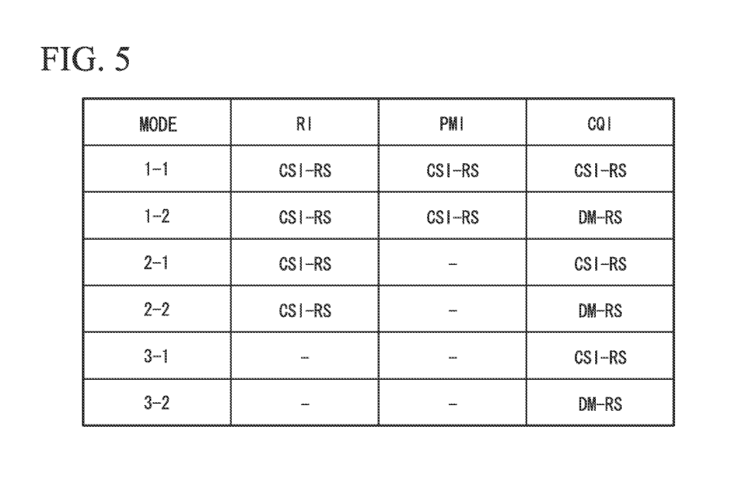

FIG. 5 is a table showing an example of the relationship between the feedback modes and the reference signals (RSs) used in measurement for the purpose of generating feedback information. In this case, the description will be for the case in which the terminal device reports the RI, PMI, and CQI to the base station as the feedback information.

The relational table shown in FIG. 5 includes information related to the first mode that performs reporting of the receiving quality using only CSI-RS, and information related to the second mode that performs reporting of the receiving quality using at least DM-RS. More specifically, the feedback mode 1-1 is a feedback mode that feeds back all of RI, PMI, and CQI, and in which the RI, PMI, and CQI are all calculated by measuring the CSI-RS. The feedback 1-2 is a feedback mode that feeds back all of RI, PMI, and CQI, and in which RI and PMI are calculated by measuring the CSI-RS. The CQI is calculated by measuring the CSI-RS.

The feedback mode 2-1 is a feedback mode in which RI and CQI are fed back, which both RI and CQI are calculated by measuring the CSI-RS. The feedback mode 2-2 is a feedback mode in which RI and CQI are fed back, in which RI is calculated by measuring the CSI-RS and CQI is calculated by measuring the DM-RS. The feedback mode 3-1 is a feedback mode in which only CQI is fed back, in which CQI is calculated by measuring the CSI-RS. The feedback mode 3-2 is a feedback mode in which only CQI is fed back, in which CQI is calculated by measuring the DM-RS.

As described above, the measurement of receiving quality using CSI-RS and the measurement of receiving quality using DM-RS each have different advantages. For this reason, a plurality of feedback modes such as shown in FIG. 5 are established beforehand, and the feedback mode is signaled in accordance with the situation. By doing this, it is possible to achieve preferable feedback from the terminal device to the base station.

For example, in the case in which, for example, at the position at which a CSI-RS is mapped, a base station that covers another cell does not transmit a signal, in the case in which it is not possible to measure the interference signal power by just measuring the CSI-RS, the terminal device uses the modes 1-2, 2-2, and 3-2 as the feedback modes. By doing this, because the terminal device measures the DM-RS and can generate feedback information that takes into consideration the interference signal power, it is possible to select the transmission parameters appropriately and perform efficient communication. Alternatively, in the case, for example, in which frequency scheduling is not performed, in which case there is no need to measure the receiving quality across the frequency direction, the terminal device uses the modes 1-2, 2-2, and 3-2 as the feedback modes.

By doing this, by scheduling, because the terminal device can generate feedback information by measuring the DM-RSs which are placed in the time direction in greater numbers than the CSI-RSs, it is possible to select preferable transmission parameters. In reverse, by the terminal device using the modes 1-1, 2-1, and 3-1 as the feedback modes, because it is possible to measure the receiving quality that provides coverage in the frequency direction, it is possible to perform frequency scheduling and to improve the efficiency of communication. Also, because the CSI-RS may always be inserted into a wireless frame, even a terminal device to which a resource block has not been allocated can report feedback information.

Although the description has been presented for the case in which the feedback mode has been associated with the CSI-RS and DM-RS, which are LTE-A reference signals, this is not a restriction. For example, association may be made to a combination of LTE reference signals (CRS (Common RS), Rel-8 CRS (Release 8 CRS)).

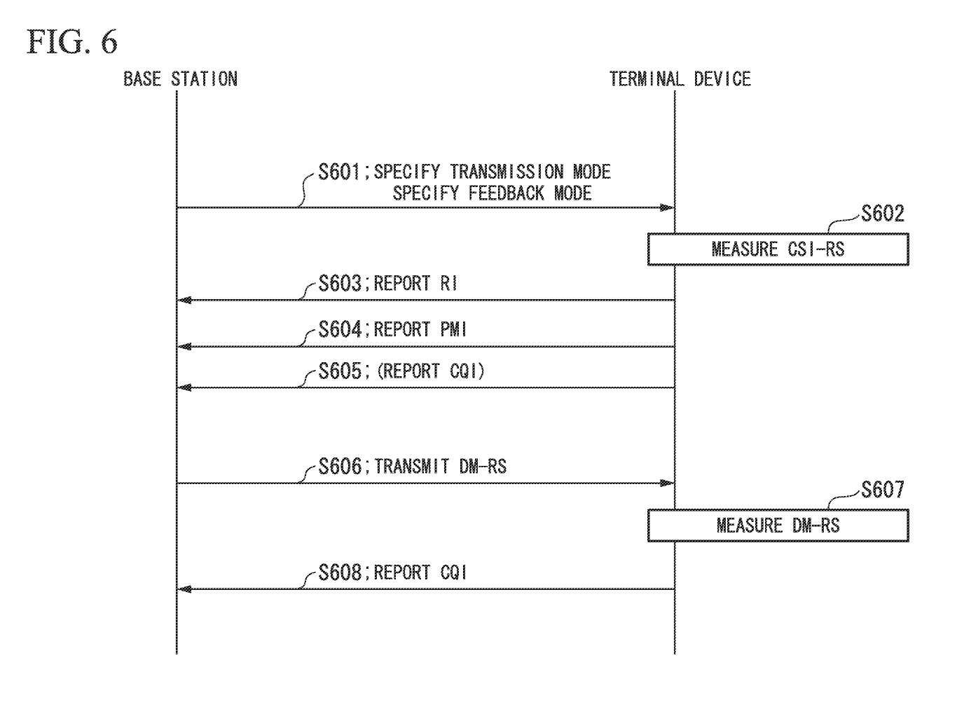

FIG. 6 is a sequence diagram showing an example of the processing between the terminal device and the base station when using the feedback mode 1-2 shown in FIG. 5.

First, the base station instructs the transmission mode and the feedback mode to the terminal device (selects and notifies of the modes) (step S601). In this case, the description will be for the case in which the base station instructs SU (Single User) MIMO mode (selects and notifies of the mode) as the transmission mode, and instructs the mode 1-2 shown in FIG. 5 as the feedback mode. The terminal device that received the instruction for mode 1-2 as the feedback mode (has acquired mode 1-2 as the feedback mode) measures the CSI-RS (step S602). The terminal device uses the measurement results from step S602, generates the RI, and reports to the base station (step S603).

Using the measurement result, the terminal device also generates the PMI and reports to the base station (step S604). Because the DM-RS is referenced when generating the CQI, in the mode 1-2, in the case in which the DM-RS is not allocated, transmission by the terminal device is not necessary, and the CQI may be generated and report made to the base station using the CSI-RS measurement result (step S605). The base station allocates a resource block to the terminal device and transmits the DM-RS (step S606). In this case, the terminal device measures the DM-RS (step S607). Then, the terminal device uses the measurement results from step S607 to generate and report the CQI (step S608). Although this description is for the case in which the DM-RS transmission at step S606 and the DM-RS measurement at step S607 are performed after step S605, these may be performed at an earlier timing.

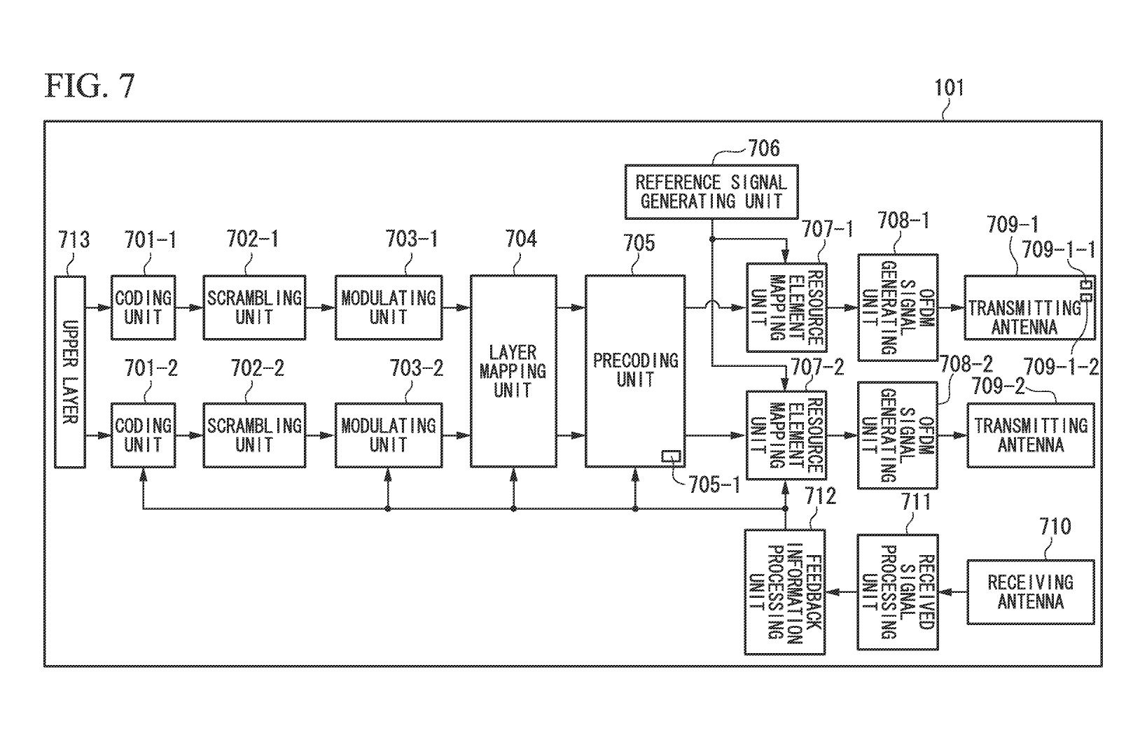

FIG. 7 is a simplified block diagram showing an example of the configuration of the base station 101 (transmission device) 101 in the present embodiment. The base station 101 includes coding units 701-1 and 701-2, scrambling units 702-1 and 702-2, modulating units 703-1 and 703-2, a layer mapping unit 704, a precoding unit 705, a reference signal generating unit 706, resource element mapping units 707-1 and 707-2, OFDM signal generating units 708-1 and 708-2, transmitting antennas 709-1 and 709-2, a receiving antenna 710, a received signal processing unit 711, a feedback information processing unit 712, and an upper-layer 713.

The upper layer 713 outputs the transmitted data (bit stream) for the number of code words for each code word to the coding units 701-1 and 701-2. The coding units 701-1 and 701-2, based on the coding rate output by the feedback information processing unit 712, performs error correction coding and rate mapping processing with respect to the signal output by the upper layer 713, and outputs the result to the scrambling units 702-1 and 702-2. The scrambling units 702-1 and 702-2 multiply the signal output by the coding units 701-1 and 701-2 by a scrambling code, and output the result to the modulating units 703-1 and 703-2. The modulating units 703-1 and 703-2, based on the modulation method output by the feedback information processing unit 712, perform modulation processing of the signal output by the scrambling units 702-1 and 702-2 for PSK (phase-shift keying) modulation or QAM (quadrature amplitude modulation) or the like and output the result to the layer mapping unit 704.

The layer mapping unit 704, based on the mapping scheme output by the feedback information processing unit 712, distributes the modulation symbol stream output from the modulating units 703-1 and 703-2 for each layer, and outputs it as the signals for the number of layers to the precoding unit 705. The precoding unit 705, based on the precoding matrix output by the feedback information processing unit 712, performs precoding processing of the modulation symbol stream for each layer output by the layer mapping unit 704, and outputs the result to the resource element mapping units 707-1 and 707-2. More specifically, the precoding unit 705 multiplies the signal output by the layer mapping unit 704 by the precoding matrix.

The reference signal generating unit 706 generates a CSI-RS and DM-RS, and outputs the result to the resource element mapping units 707-1 and 707-2. As the streams used for the CSI-RS and the DM-RS, for example, the CSI-RS can use the streams that are generated based on a cell ID, and the DM-RS can use the streams that are generated based on the cell ID and a user ID. By doing this, it is possible to reduce the interference between the cells. Usually, the same precoding processing as that of the data signal is performed on the DM-RS. Because of this, the reference signal generating unit 706 may output the DM-RS to the resource element mapping units 707-1 and 707-2 via the precoding unit 705.

The resource element mapping units 707-1 and 707-2, based on the modulation symbol and the DM-RS mapping schemes output by the feedback information processing unit 712, map the modulation symbol stream precoded in the precoding unit 705 and the CSI-RSs and the DM-RSs that are generated by the reference signal generating unit 706 onto the prescribed resource elements, and output the results to the OFDM signal generating units 708-1 and 708-2. In this case, the resource element mapping units 707-1 and 707-2 map the CSI-RSs onto only the prescribed subframes and map the DM-RSs based on scheduling of each of the terminal device.

The OFDM signal generating units 708-1 and 708-2 convert the group of resource blocks output from the resource element mapping units 707-1 and 707-2 to OFDM signals and output the results to the transmitting antennas 709-1 and 709-2 as signals for the number of transmitting antennas. The transmitting antennas 709-1 and 709-2 transmit the signals output by the OFDM signal generating units 708-1 and 708-2 as downlink transmitted signals to the terminal device or the like.

The receiving antenna 710 receives the uplink received signal that is transmitted from the terminal device or the like and outputs it to the received signal processing unit 711. The received signal processing unit 711, after performing prescribed processing of the signal output from the receiving antenna 710, outputs the feedback information to the feedback information processing unit 712. The feedback information processing unit 712, using the information output by the received signal processing unit 711, that is the feedback information reported from the terminal device, changes items such as the coding rate in the coding units 701-1 and 701-2, the modulation method in the modulating units 703-1 and 703-2, the mapping scheme in the layer mapping unit 704, the precoding matrix in the precoding unit 705, and the modulation symbol and the DM-RS mapping schemes (in which scheduling is considered) in the resource element mapping units 707-1 and 707-2. The feedback information processing unit 712 outputs each changed information to the coding units 701-1 and 701-2, the modulating units 703-1 and 703-2, the layer mapping unit 704, and the precoding unit 705.

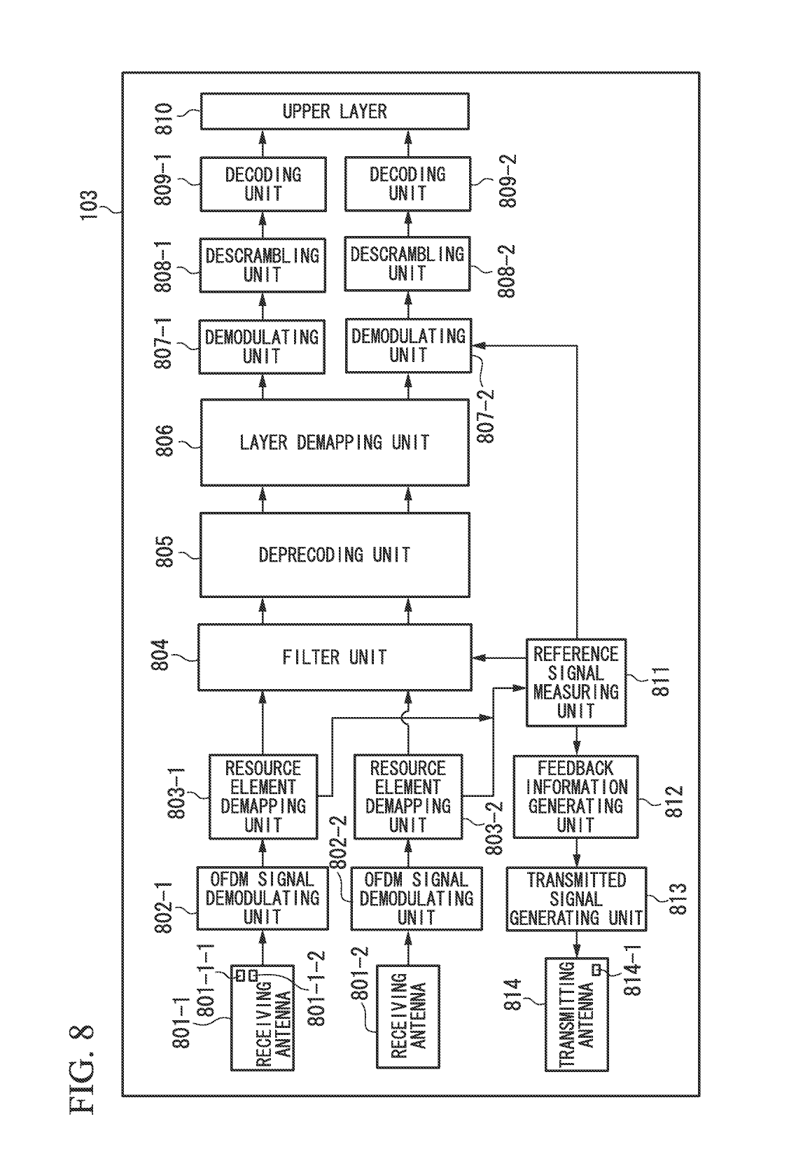

FIG. 8 is a simplified block diagram showing an example of the configuration of a terminal device 103 (receiving device) in the present embodiment. Because the configuration of the terminal device 102 (FIG. 1) is the same as that of the terminal device 103, its description will be omitted herein.

The terminal device 103 has receiving antennas 801-1 and 801-2, OFDM signal demodulating units 802-1 and 802-2, resource element demapping units 803-1 and 803-2, a filter unit 804, a deprecoding unit 805, a layer demapping unit 806, demodulating units 807-1 and 807-2, descrambling units 808-1 and 808-2, decoding units 809-1 and 809-2, an upper layer 810, a reference signal measuring unit 811, a feedback information generating unit 812, a transmitted signal generating unit 813, and a transmitting antenna 814.

The receiving antennas 801-1 and 801-2 output the downlink received signals received from the base station 101 or the like as the signals for the number of receiving antennas to the OFDM signal demodulating units 802-1 and 802-2. The OFDM signal demodulating units 802-1 and 802-2 perform OFDM demodulation processing of the signals output by the receiving antennas 801-1 and 801-2, and output signals for a resource block group to the resource element demapping units 803-1 and 803-2.

The resource element demapping units 803-1 and 803-2 output the reference signals (the CSI-RS and the DM-RS) to the reference signal measurement unit 811 based on signals output by the OFDM signal demodulating units 802-1 and 802-2. The resource element demapping units 803-1 and 803-2 output the received signals in resource elements other than resource elements onto which reference signals are mapped to the filter unit 804, based on signals output by the OFDM signal demodulating units 802-1 and 802-2.

The filter unit 804 performs filtering processing, using the measurement results of the DM-RSs measured by the reference signal measuring unit 811, with respect to the received signals output from the resource element demapping units 803-1 and 803-2, and outputs the results to the deprecoding unit 805. The deprecoding unit 805 performs deprecoding processing with respect to the signal that was filtered by the filter unit 804, this corresponding to the precoding done by the precoding unit 705, and outputs signals for the number of layers to the layer demapping unit 806. The layer demapping unit 806 performs joining processing with respect to the signals output by the deprecoding unit 805, this corresponding to the layer mapping unit 704, converts the signals for each layer to signals for each code word, and outputs the result to the demodulating units 807-1 and 807-2.

The demodulating units 807-1 and 807-2 perform demodulation processing, using the measurement results of the DM-RSs measured by the reference signal measuring unit 811, with respect to the signals for each code word converted by the layer demapping unit 806, this corresponding to the modulation processing in the modulating units 703-1 and 703-2, and output the results to the descrambling units 808-1 and 808-2. The descrambling units 808-1 and 808-2 multiply the signals output by the demodulating units 807-1 and 807-2 by the conjugate code of the scrambling code used in the scrambling units 702-1 and 702-2 (divide by the scrambling code), and output the results to the decoding units 809-1 and 809-2. The decoding units 809-1 and 809-2 perform rate demapping processing and error correction decoding processing with respect to the signals output by the decscrambling units 808-1 and 808-2, obtain received data for each code word for the number of code words, and output signals to the upper layer 810.

In this case, in the filtering processing performed by the filter unit 804, the transmitted signals of each of the transmitting antennas 709-1 and 709-2 in FIG. 7 are detected from the received signals for each of the receiving antennas 801-1 and 801-2, using a method such as ZF (zero forcing), MMSE (minimum mean square error), or MLD (maximum likelihood detection). It is possible to perform processing at the filter unit 804 and processing at the deprecoding unit 805 simultaneously when detecting the transmitted signals of each layer using the measurement results of the DM-RSs that are precoded in the same manner as data.

The reference signal measuring unit 811 measures the reference signals acquired in the resource element demapping units 803-1 and 803-2, and outputs the measurement results to the feedback information generating unit 812. In this process, the reference signal measuring unit 811 switches between whether the CSI-RS measurement results or the DM-RS measurement results are to be output to the feedback information generating unit 812 by feedback mode. The reference signal measuring unit 811 also outputs the DM-RS measurement results to the filter unit 804 and to the demodulating units 807-1 and 807-2.

The feedback information generating unit 812 generates feedback information such as RI, PMI, CQI, or CSI based on feedback mode using the measurement results of reference signal output from the reference signal measuring unit 811, and outputs the results to the transmitted signal generating unit 813.

The transmitted signal generating unit 813 converts the feedback information generated by the feedback information generating unit 812 to a transmitted signal, and outputs the result to the transmitting antenna 814. The transmitting antenna 814 transmits the signal output by the transmitted signal generating unit 813 to the base station 101 and the like as the uplink transmitted signal.

In this manner, a feedback mode that measures a receiving quality for feedback (or propagation channel condition) using the CSI-RSs and a feedback mode that measures a receiving quality for feed back (or the propagation channel condition) using the DM-RS are established beforehand, and these modes are used by switching therebetween. By doing this, the terminal device can generate the feedback information with high accuracy. Efficient feedback from the terminal device to the base station is also possible.

The precoding unit 705 of the base station 101, which is a transmission device, functions as a selecting unit 705-1.

The transmitting antenna 709-1 of the base station 101 functions as the transmitting unit 709-1-1 and the notifying unit 709-1-2. The transmitting antenna 709-2, similarly, functions as the transmitting antenna 709-1.

In the base station 101, the reference signal transmitting unit 709-1-1 transmits common reference signals and receiving device-specific reference signals to the terminal device, which is the receiving device.

In the base station 101, the selecting unit 705-1 selects either a first mode that reports the receiving quality using only the common reference signal and a second mode that reports the receiving quality using at least the receiving device-specific reference signal.

In the base station 101, the mode selected by the selecting unit 705-1 is notified to the terminal device, which is the receiving device.

In the present embodiment, a mode that reports the receiving quality that uses a common reference signal and a receiving device-specific reference signal may be used as the second mode.

In the present embodiment, a mode that reports the receiving quality in a part of the frequency band in which transmission is possible may be used as the second mode.

In the present embodiment, a mode that reports the receiving quality in all of the frequency band and that reports the receiving quality in a part of the frequency band in which transmission is possible, may be used as the second mode.

In the present embodiment, a mode that reports the receiving quality more frequently than the first mode may be used as the second mode.

The receiving antenna 801-1 of the terminal device 103, which is a receiving device, functions also as the receiving unit 801-1-1 and the acquiring unit 801-1-2. The receiving antenna 801-2 similarly functions as the receiving antenna 801-1. The transmitting antenna 814 of the terminal device 103 functions as the reporting unit 814-1.

In the terminal device 103, the receiving unit 801-1-1 receives the common reference signal and the receiving device-specific reference signal transmitted from the base station 101, which is the transmission device.

In the terminal device 103, the reporting unit 814-1 makes a report to the base station 101, which is the transmission device, of the receiving quality using at least the receiving device-specific reference signal.

In the terminal device 103, the receiving unit 801-1-1 may receive the common reference signal and the receiving device-specific reference signal transmitted from the base station 101, which is the transmission device. The reporting unit 814-1 may switch between reporting to the base station 101 the receiving quality using only the common reference signal and at least reporting thereto the receiving quality using the receiving device-specific reference signal.

In the terminal device 103, the receiving unit 801-1-1 may receive the common reference signal and the receiving device-specific reference signal transmitted from the base station 101, which is the transmission device. The acquiring unit 801-1-2 may acquire from the base station 101, either the first mode, which reports the receiving quality using only the common reference signal, or the second mode, which reports the receiving quality using at least the receiving device-specific reference signal. Then, if the mode that was acquired by the acquiring units 801-1-1 is the first mode, the reporting unit 814-1 may report to the base station 101 the receiving quality using only the common reference signal, and if the mode acquired by the acquiring unit 801-1-2 is the second mode, the reporting unit 814-1 may report to the base station 101 the receiving quality using at least the receiving device-specific reference signal.

### Second Embodiment

In the first embodiment, the description was for the case in which an association is made between the feedback mode and the type of reference signal used in the measurement for generation of RI, PMI, and CQI. In the second embodiment of the present invention, the description will be for the case in which an association is made between the feedback mode and the type of reference signal used in the measurement for generation of frequency-selective or frequency non-selective feedback information.

The present embodiment will be described below, with references made to the drawings.

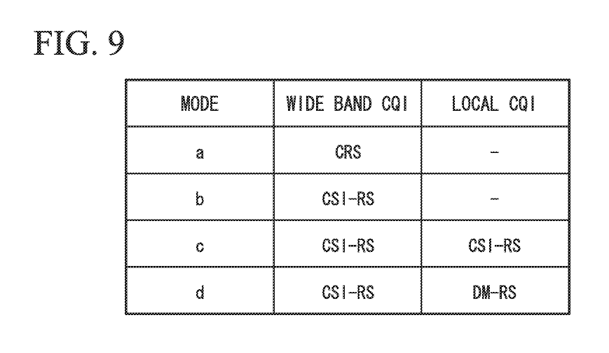

FIG. 9 is a table showing an example of the relationship between the feedback modes and the reference signals used in measurement for the purpose of generating feedback information. In this case, the description will be for the case in which the Wideband CQI, which is frequency non-selective feedback information or the Local CQI, which is frequency selective feedback information is reported by the terminal device to the base station as the feedback information.

The relational table shown in FIG. 9 includes first mode information that reports the receiving quality using only the CSI-RS and second mode information that reports the receiving quality using at least the DM-RS. More specifically, the feedback mode a is a feedback mode that feeds back the Wideband CQI, in which the Wideband CQI is calculated by measuring the CRS. The feedback mode b is a feedback mode that feeds back the Wideband CQI, in which the Wideband CQI is calculated by measurement of the CSI-RS. The feedback mode c is a feedback mode that feeds back the Wideband CQI and the Local CQI, in which the Wideband CQI and the Local CQI are calculated by measurement of the CSI-RS. The feedback mode d is a feedback mode that feeds back the Wideband CQI and the Local CQI, in which the Wideband CQI is calculated by measurement of the CSI-RS and the Local CQI is calculated by measurement of the DM-RS.

In this case, the Wideband CQI is the receiving quality (or propagation channel condition) over the entire system bandwidth (or the overall component carrier bandwidth, overall bandwidth allocatable to the terminal device, and the overall bandwidth over which transmission is possible by the transmission device). The Local CQI is the receiving quality (or propagation channel condition) over a part of the system bandwidth (or a part of the component carrier bandwidth). A part of the system bandwidth (or a part of the component carrier bandwidth) is a bandwidth in which the terminal device is allocated, a bandwidth extracted from the system bandwidth based on a priorly established rule, or a bandwidth specified by the base station and by the upper layer within the system bandwidth, and need not be the same bandwidth at all times. Also, in the case in which the system bandwidth is divided into a plurality of bandwidths and reporting is successively done of the receiving quality in each of the bandwidths, each of the reports is referred to as the Local CQI. The term CQI used in this case means the receiving quality (or propagation channel condition). The feedback information may be an index other than the CQI, such as the RI, RMI or the like, that indicates the receiving quality (or propagation channel condition).

As described with regard to the first embodiment, the measurement of receiving quality using CSI-RS and the measurement of receiving quality using DM-RS each have different advantages. For this reason, a plurality of feedback modes such as shown in FIG. 9 are established beforehand, and the feedback mode is signaled in accordance with the situation, so that preferable feedback is achieved.

For example, in the case in which, for example, frequency scheduling is not performed, it is not necessary to measure the receiving quality with coverage over the frequency direction, the modes a, b, and d are used as the feedback modes. In the case of using mode a, or mode b, because it is possible to suppress the amount of information that is fed back, it is possible to perform feedback efficiently. In the case of using mode d, because it is possible to generate the feedback information by the terminal device measuring the DM-RSs, which are placed more frequently in the time direction than the CSI-Rs, it is possible to select preferable transmission parameters. Also, the terminal device reports to the base station the receiving quality using the Wideband CQI that uses the CSI-RS in a bandwidth other than a bandwidth that is allocated to itself.

For this reason, even in the case, for example, in which communication of a control signal or the like is done in a bandwidth other than the bandwidth that is locally allocated, it is possible for the base station to determine the control information transmission parameters by referencing the Wideband CQI. In reverse, by using mode c as the feedback mode, because it is possible to measure the receiving quality that covers in the frequency direction, it is possible to perform frequency scheduling, and possible to improve the communication efficiency. Also, the CSI-RS can always be inserted in a wireless frame. For this reason, it is possible for even a terminal device to which a resource block is not allocated to report feedback information to the base station. The Wideband CQI in the modes b, c, and d achieves the same effect even if generation is done using the CRS.

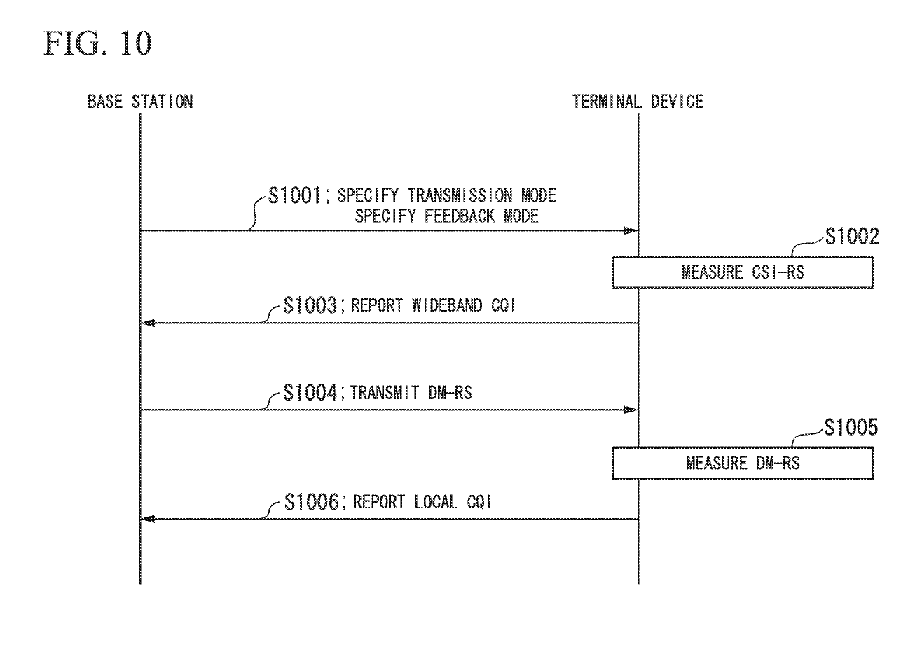

FIG. 10 is a sequence diagram showing an example of the processing between the base station and the terminal device when the feedback mode d in FIG. 9 is used.

First, base station instructs the transmission mode and feedback mode to the terminal device (selects and notifies of the modes) (step S1001). In this case, the description is for the case in which the base station instructs the terminal device of the SU-MIMO mode as the transmission mode and instructs the mode d shown in FIG. 9 as the feedback mode. The terminal device that received the instruction for the mode d as the feedback mode (has acquired mode d as the feedback mode) measures the CSI-RS (step S1002). Then, the terminal device uses the measurement results from step S1002, generates the Wideband CQI, and reports to the base station (step S1003).

The base station allocates a resource block to the terminal device, and transmits the DM-RS (step S1004). In this case, the terminal device measures the DM-RS (step S1005). Then, the terminal device uses the measurement results from step S1005, generates the Local CQI, and reports to the base station (step S1006). Although this description is for the case in which the processing for the transmission of the DM-RS at step S1004 and the processing for the measurement of the DM-RS at step S1005 are performed after step S1003, these may be performed at an earlier timing.

In this manner, the feedback mode for measurement of the receiving quality (or propagation channel condition) for feedback using the CSI-RS and the feedback mode for measurement of the receiving quality (or propagation channel condition) for feedback using the DM-RS are established beforehand. Then, the terminal device switches and uses these modes. By doing this, the terminal device can generate feedback information with high accuracy. It is also possible to perform efficient feedback from the terminal device to the base station.

### Third Embodiment

In the first embodiment, the description is for the case in which an association is made between the feedback mode and the type of reference signal used in measurement for RI, PMI, and CQI generation. In the third embodiment of the present invention, the description will be for the case in which an association is made between the feedback mode and the type of reference signal used in measurement for generation of Explicit/Implicit feedback information.

The present embodiment is described below, with references made to the drawings.

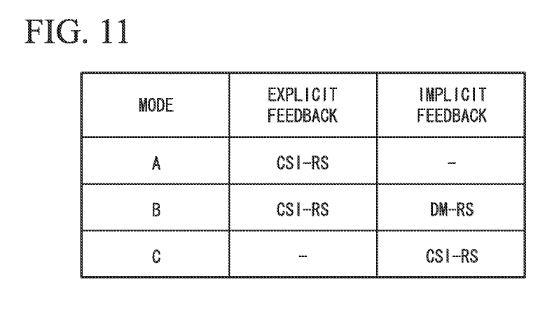

FIG. 11 is a table showing an example of the relationship between the feedback modes and the reference signals used in measurement for the purpose of generating of feedback information. In this case, the description will be for the case in which the terminal device reports the CSI, which is explicit feedback information or the RI/PMI/CQI, which is implicit feedback information, as the feedback information.

The relational table shown in FIG. 11 includes information of a first mode that reports the receiving quality using only the CSI-RS, and information of a second mode that reports receiving quality using at least the DM-RS. More specifically, the feedback mode A is a feedback mode that feeds back the CSI, in which the CSI is calculated by measurement of the CSI-RS. The feedback mode B is a feedback mode that feeds back the CSI and the CQI, in which the CSI is calculated by measurement of the CSI-RS, and the CQI is calculated by measurement of the DM-RS. The feedback C is a feedback mode that feeds back RI/PMI/CQI, in which RI/PMI/CQI is calculated by measurement of the CSI-RS.

In this case, the explicit feedback information is feedback information that does not take the processing within the transmission device and the processing within the receiving device into consideration. The implicit feedback information is feedback information that takes the processing within the transmission device and the processing within the receiving device into consideration.

As described with regard to the first embodiment, the measurement of receiving quality using CSI-RS and the measurement of receiving quality using DM-RS each have different advantages. For this reason, a plurality of feedback modes such as shown in FIG. 11 are established beforehand, and the feedback mode is signaled in accordance with the situation, so that preferable feedback is achieved.

In general, in the case in which interference signal electrical power and noise electrical power are considered, the amount of amount of explicit feedback information is greater than the amount of implicit feedback information, and the degree of transmission processing freedom (for example, rank selection and precoding matrix setting) improves. For example, in the case of being able to sufficiently establish resources for reporting feedback information, the mode A is used as the feedback mode. By doing this, the degree of freedom in transmission processing is improved, as is communication efficiency. In the case of using the mode B, it is possible to suppress the amount of information fed back in comparison with the mode A. Also, because the CQI is generated using the DM-RS, it is possible to shorten the period of transmitting the CQI. In the case of using the mode C, it is possible to further suppress the amount of information fed back in comparison with the mode B, and it is possible to improve the feedback efficiency.

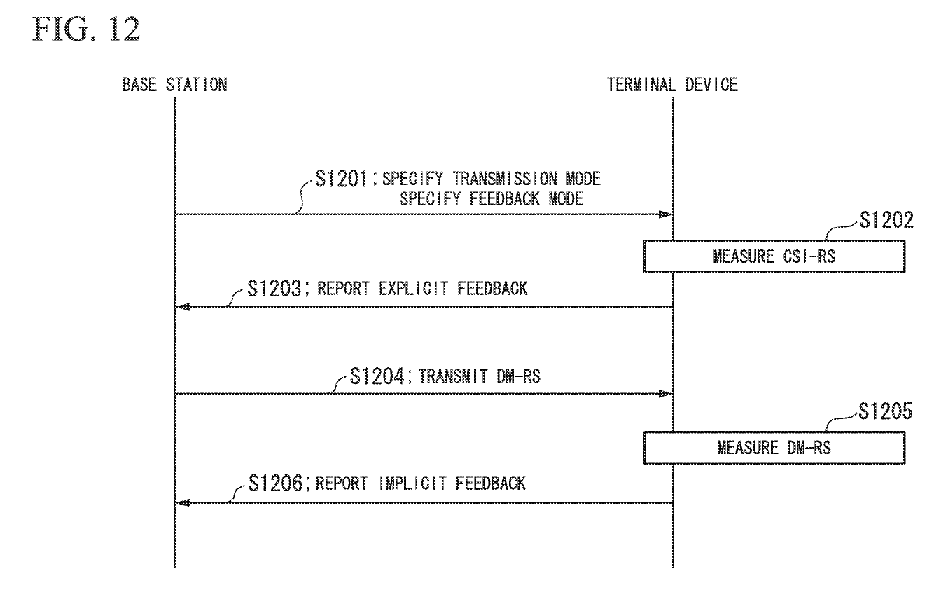

FIG. 12 is a sequence diagram showing an example of the processing performed between the base station and the terminal device when using the feedback mode B shown in FIG. 11.

First, the base station instructs the transmission mode and the feedback mode to the terminal device (selects and notifies of the modes) (step S1201). In this case, the description is for the case in which the base station instructs to the terminal device the SU-MIMO mode as the transmission mode and instructs the mode B in FIG. 11 as the feedback mode. The terminal device that has received the mode B instruction as the feedback mode (has acquired the mode B as the feedback mode) measures the CSI-RS (step S1202).

Then, the terminal device uses the measurement result from step S1202 and generates and reports the CSI (step S1203). The base station allocates a resource block to the terminal device and transmits the DM-RS (step S1204). In this case, the terminal device measures the DM-RS (step S1205). The terminal device uses the measurement results from step S1205 to generate the CQI and report to the base station (step S1206). Although this description is for the case in which the processing for the transmission of the DM-RS at step S1204 and the processing for the measurement of the DM-RS at step S1205 are performed after step S1203, these may be performed at an earlier timing.

In this manner, the feedback mode for measurement of the receiving quality (or propagation channel condition) for feedback using the CSI-RS and the feedback mode for measurement of the receiving quality (or propagation channel condition) for feedback using the DM-RS are established beforehand. Then, the terminal device switches and uses these modes. By doing this, feedback information can be generated with high accuracy. It is also possible to perform efficient feedback.

### Fourth Embodiment

In the first to third embodiments, the descriptions were for the case in which an association is made between the feedback mode and the type of reference signal used in measurement for generating the feedback information. In the fourth embodiment of the present invention, the description will be for the case in which an association is made between the feedback mode and the transmission mode.

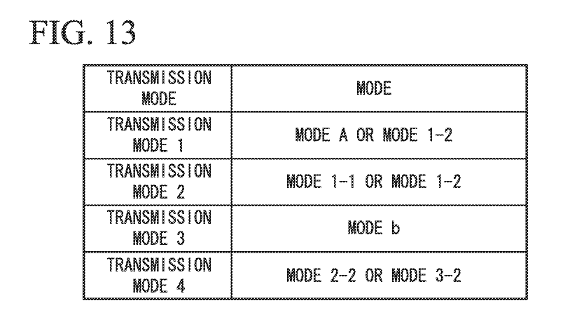

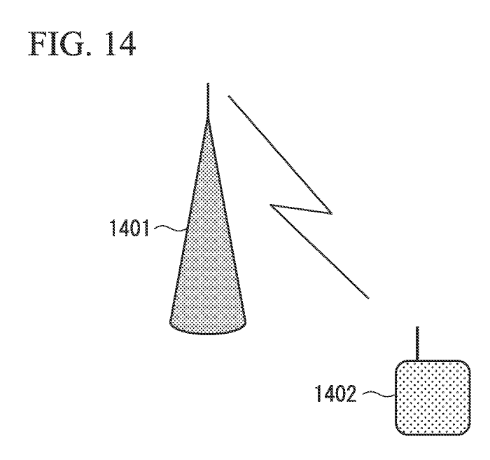

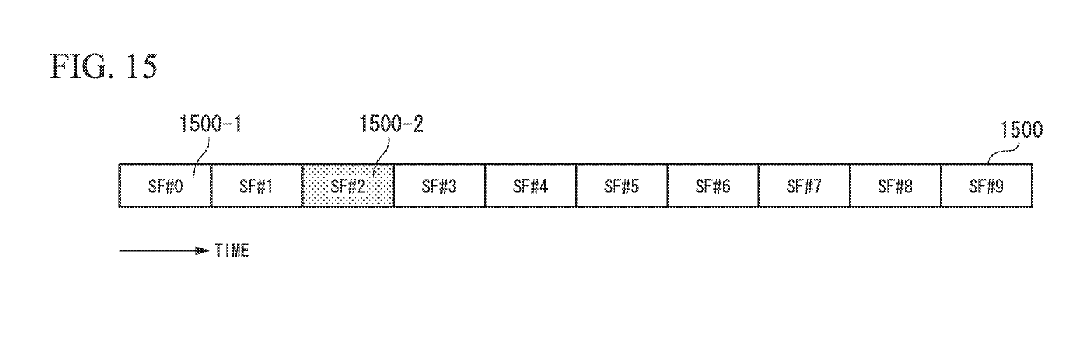

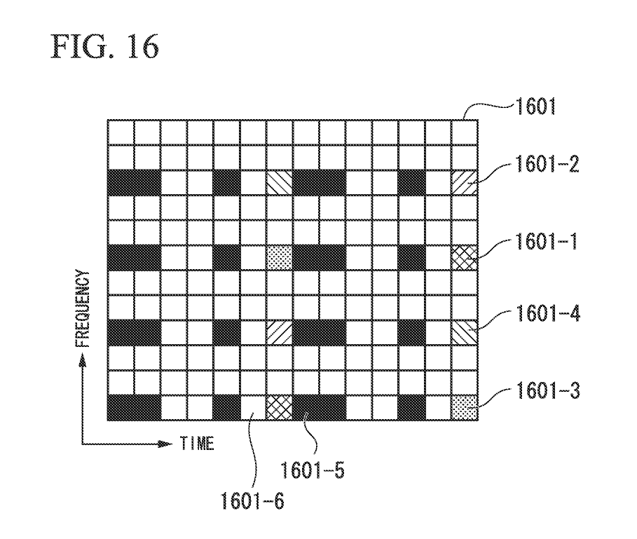

FIG. 13 is a table showing an example of the relationship between the transmission modes and the feedback modes. In this case, each of the feedback modes are the feedback modes in FIG. 5, FIG. 9, and FIG. 11. In the transmission mode 1, the mode A in FIG. 11 or the mode 1-2 in FIG. 5 is used as the feedback mode. In the transmission mode 2, the mode 1-1 or the mode 1-2 in FIG. 5 is used as the feedback mode. In the transmission mode 3, the mode b in FIG. 9 is used as the feedback mode. In the transmission mode 4, the mode 2-2 in FIG. 5 is used as the feedback mode.

As described with regard to the first embodiment, processing of the measurement of receiving quality using CSI-RS and processing of the measurement of receiving quality using DM-RS each have different advantages. For this reason, a plurality of feedback modes such as shown in FIG. 5, FIG. 9, and FIG. 11 are established beforehand, and the feedback mode and the transmission mode are associated, so that preferable feedback is achieved in accordance with the transmission mode.

For example, a transmission mode in which the feedback information is used to control a large number of transmission parameters, such as the number of ranks, the precoding matrix or MCS, and also interference signals on the CSI-RS are suppressed by data signal puncturing, such as the closed-loop CoMP (Coordinated Multiple Point) transmission mode, is used with respect to a terminal device having relatively small channel time variation. When this is done, because time can be taken in reporting feedback information (using an uplink resource that spreads over a plurality of subframes), the mode A, which reports explicit feedback information having a large amount of information, or the mode 1-2, which measures the CSI-RSs that are placed in the time direction with a relatively low density, calculates the RI and PMI and calculates the CQI using the DM-RS, is used. By doing this, because it is possible to perform communication with preferable transmission parameters, the communication efficiency is improved. In the same manner, the mode A or the mode 1-2 may be used for controlling the transmission mode parameters in the closed-loop MIMO transmission mode as well.

The closed-loop MIMO transmission mode as well, in which feedback information is used to control a large number of transmission parameters, such as number of ranks, the precoding matrix or MCS, and also to measure the CSI-RS at the local cell, thereby enabling consideration of interference signals, is used with respect to a terminal device having a relatively small channel time variation. When this is done, the mode 1-1, which measures the CSI-RSs that are placed in the time direction with a relatively low density and calculates the RI and PMI, or the mode 1-2, which uses the DM-RS to calculate the CQI by measurement of the DM-RS is used. By doing this, while the amount of information in the feedback information is made smaller compared to the transmission mode 1, it is possible to communicate with preferable communication parameters, so that the communication efficiency is improved. In the same manner, because the closed-loop CoMP transmission mode is used for a terminal device having relatively small channel time variations, the mode 1-1 may be used.

The open-loop CoMP transmission mode that controls only the MCS using the feedback information and that also controls interference signals on the CSI-RS by data signal puncturing does not require frequency scheduling. For this reason, the terminal device uses the mode b, which feeds back only the Wideband CQI. By doing this, the amount of information of the feedback information can be reduced. The inter-cell interference on the CSI-RS is controlled by data signal puncturing, and by using this CSI-RS it is possible to generate feedback information with high accuracy. By doing this, it is possible to perform communication with preferable transmission parameters. In the same manner, because the closed-loop MIMO or the transmission diversity transmission mode does not require frequency scheduling, the mode b may be used.

The transmission diversity or the open-loop MIMO transmission mode, which use the feedback information to control only the MCS, do not require frequency scheduling. For this reason, the mode 2-2 or the mode 3-2, which feeds back only the Wideband CQI, is used. By doing this, it is possible to reduce the amount of information in the feedback information. The transmission diversity or open-loop MIMO transmission mode is used in the terminal device having relatively high-speed movement. For this reason, the terminal device can, by using the DM-RS, which is placed more frequently in the time direction than the CSI-RS, generate highly accurate feedback information with a short time period. By doing this, it is possible to perform communication with preferable transmission parameters.

In the same manner, the open-loop CoMP transmission mode is also used in terminal devices having relatively high-speed movement. For this reason, the terminal device may also use the mode 2-2 and the mode 3-2. Semi-persistent scheduling (SPS), in which a resource blocks are allocated across a plurality of subframes with allocation instructions with one timing, is not a transmission mode. In the same manner as for a transmission mode, however, by instructing the feedback mode d or 3-2 to a terminal device to which SPS has been used to allocate a resource block (selection and notification of the mode), because it is possible to establish DM-RSs for the purpose of feedback information generation over a plurality of subframes, it is possible to perform efficient feedback. In particular, because by making the resource block allocation fixed during the SPS (turning the hopping flag off), the frequencies of resource blocks allocated by SPS are fixed, the setting of the transmission parameters referencing the feedback information is made efficient.

In this manner, the feedback mode for using the CSI-RS to measure the receiving quality (or propagation channel condition) for feedback and the feedback mode for using the DM-RS to measure the receiving quality (or propagation channel condition) for feedback are established beforehand. Then, the terminal device switches and uses these feedback modes. Additionally, the feedback modes that can be used corresponding to transmission modes are limited beforehand. By doing this, it is possible to generate with high accuracy feedback information corresponding to the transmission mode. It is also possible to perform efficient feedback.

In each of the above-noted embodiments, an association between the feedback mode and the type of reference signal used in measuring for the generation of feedback information, or an association between the transmission mode and the feedback mode are merely examples, and other combinations may be used. Also, in each of the above-noted embodiments, it is not necessary to use all of the associations between the feedback mode and the type of reference signal used in measuring for the generation of feedback information, or the associations between the transmission mode and the feedback. Even if a part thereof is switched, it is possible to achieve the effect of the present invention.

Also, it is possible to use the combination of a plurality of the feedback modes shown in each of the above-noted embodiments as one feedback mode. As a method of combining feedback modes, for example, it is possible to use a feedback mode in which, after repeating the mode b a prescribed number of times (including one time), the mode A is repeated a prescribed number of times. Alternatively, in a combination of the mode c, the mode A, and the mode C, when generating the Wideband CQI within the mode c, the CSI-RS is used to generate implicit feedback information (mode C), and when generating Local CQI, the CSI-RS is used to generate the explicit feedback information (mode A). In this manner, by forming one feedback mode as the combination of a plurality of feedback modes, it is possible to achieve the plurality of effects of each of the above-noted embodiments.

In each of the above-noted embodiments, although the descriptions were for the case in which the resource element was used as the unit of mapping the reference signals, the resource block was used as the terminal device allocation unit, and subframes and wireless frames were used as the transmission units in the time direction, these are not restrictions. The same effect can be achieved even if a region with an arbitrary frequency and time and time unit are alternatively used. For example, the same effect can be achieved by dividing the resource block used in each of the above-noted embodiments in the time direction and by defining each as a new resource block.

Also, although the descriptions of each of the above-noted embodiments were for the case in which the transmission mode and feedback mode are instructed (selection and notification of the modes) from the base station to the terminal device with the same timing, this is not a restriction. For example, an instruction can be given to update the feedback mode only, without changing the transmission mode. Also, although the transmission mode instruction and the feedback mode instruction were both described for the case of performing upper-layer signaling, this is not a restriction. For example, the transmission mode instruction can be done by upper-layer signaling, and the feedback mode instruction can be done via a control channel on a physical layer.

Alternatively, a program for the purpose of implementing all or part of the functions of the base station in FIG. 7 and all or part of the functions of the terminal device in FIG. 8 may be recorded on a computer-readable recording medium, and a computer system may read and execute the program recorded on the record medium, thereby performing the various parts of processing. The term “computer system” includes an operating system and also hardware, such as peripheral devices.

The term “computer system” also includes a webpage-providing environment (or display environment) if the WWW system is used.

The term “computer-readable medium” refers to a portable medium, such as a flexible disk, an optical-magnetic disc, a ROM, and a CD-ROM, and a storage device, such as a hard disk, that is built into a computer system. The term “computer-readable medium” includes something that dynamically retains a program for a short time, for example, a communication line when the program is transmitted via a network such as the Internet, a communication line such as a telephone line, or the like, as well as a medium to retain a program for a certain time, for example, a flash memory internally provided in a computer system acting as the server and client in that case. The program may have the object of implementing a part of the above-described function, and it may also implement the above-described function in combination with a program already stored in a computer system.

Alternatively, implementation of all or part of the function of the base station in FIG. 7 and all or part of the function of the terminal device in FIG. 8 may be done by incorporation into an integrated circuit. Each of the functional blocks of the base station device and the terminal device may be implemented as individual chips, or may be integrated by a part or all part thereof and implemented as chips. The method of circuit integration may be not only by an LSI but also by a dedicated communication circuit or by a general-purpose processor. In the case of the appearance of integrated circuit technology which take the place of LSIs by advancements in semiconductor technology, it is still possible to use an integrated circuit according to the present art.

Although the embodiments of the present invention are described above with references made to the accompanying drawings, the specific configuration is not limited to the embodiments, and various designs, changes and the like are encompassed within the scope thereof, without departing from the scope of the present invention.

### INDUSTRIAL APPLICABILITY

The present invention is preferable for use as a wireless transmission device, a wireless receiving device, a wireless communication system, and a wireless communication method.

### REFERENCE SYMBOLS

101: Transmission device
102, 103: Receiving device
201: Wireless frame
201-1, 201-2: Subframe
301, 302, 303, 401, 402, 403, 404: Resource block
401-1 to 401-7, 402-1 to 402-5, 403-1 to 403-3, 404-1: Resource element
701-1, 701-2: Coding unit
702-1, 702-2: Scrambling unit
703-1, 703-2: Modulating unit
704: Layer mapping unit
705: Precoding unit
706: Reference signal generating unit
707-1, 707-2: Resource element mapping unit
708-1, 708-2: OFDM signal generating unit
709-1, 709-2: Transmitting antenna
710: Receiving antenna
711: Received signal processing unit
712: Feedback information processing unit
713: Upper layer
801-1, 801-2: Receiving antenna
802-1, 802-2: OFDM signal demodulating unit
803-1, 803-2: Resource element demapping unit
804: Filter unit
805: Deprecoding unit
806: Layer demapping unit
807-1, 807-2: Demodulating unit
808-1, 808-2: Descrambling unit
809-1, 809-2: Decoding unit
810: Upper layer
811: Reference signal measuring unit
812: Feedback information generating unit
813: Transmitted signal generating unit
814: Transmitting antenna
1401: Transmission device
1402: Receiving device
1500: Wireless frame
1500-1, 1500-2: Subframe
1601: Resource block
1601-1 to 1601-6: Resource element

1. A transmission device comprising:
a transmitting unit that transmits a common reference signal and a receiving device-specific reference signal to a receiving device;
a selecting unit that selects either a first mode reporting a receiving quality using only the common reference signal or a second mode reporting a receiving quality using at least the receiving device-specific reference signal; and
a notifying unit that notifies a mode selected by the selecting unit to the receiving device.

2. The transmission device according to claim 1, wherein the second mode reports a receiving quality using the common reference signal and the receiving device-specific reference signal.

3. The transmission device according to claim 1, wherein the second mode reports a receiving quality in a part of the frequency band in which transmission is possible.

4. The transmission device according to claim 1, wherein the second mode is a mode that reports a receiving quality in both all and a part of the frequency band in which transmission is possible.

5. The transmission device according to claim 1, wherein the second mode is a mode that reports a receiving quality with a higher frequency of occurrence than that of the first mode.

6. A receiving device comprising:
a receiving unit that receives a common reference signal and a receiving device-specific reference signal transmitted from the transmission device; and
a reporting unit that reports to the transmission device a receiving quality using at least the receiving device-specific reference signal.

7. A receiving device comprising:
a receiving unit that receives a common reference signal and a receiving device-specific reference signal transmitted from the transmission device; and
a reporting unit that switches between reporting to the transmission device a receiving quality using only the common reference signal and a report thereto a receiving quality using at least the receiving device-specific reference signal.

8. A receiving device comprising:
a receiving unit that receives a common reference signal and a receiving device-specific reference signal transmitted from the transmission device;
an acquiring unit that acquires from the transmission device either a first mode that reports the receiving quality using only the common reference signal, or a second mode that reports the receiving quality using at least the receiving device-specific reference signal; and
a reporting unit that, if the mode acquired by the acquiring unit is the first mode, reports to the transmission device the receiving quality using only the common reference signal, and that, if the mode acquired by the acquiring unit is the second mode, reports to the transmission device the receiving quality using at least the receiving device-specific reference signal.

9. A communication system comprising a transmission device and a receiving device, wherein
the transmission device comprises:
a transmitting unit that transmits a common reference signal and a receiving device-specific reference signal;
a selecting unit that selects either a first mode that reports the receiving quality using only the common reference signal, or a second mode that reports the receiving quality using at least the receiving device-specific reference signal; and
a notification unit that notifies a mode selected by the selecting unit to the receiving device; and wherein
the receiving device comprises:
an acquiring unit that acquires the mode selected by the transmission device; and
a reporting unit that, if the mode acquired by the acquiring unit is the first mode, reports to the transmission device the receiving quality using only the common reference signal, and that, if the mode acquired by the acquiring unit is the second mode, reports to the transmission device the receiving quality using at least the receiving device-specific reference signal.

10. A communication method comprising:
transmitting a common reference signal and a receiving device-specific reference signal to a receiving device;
selecting either a first mode that reports the receiving quality using only the common reference signal, or a second mode that reports the receiving quality using at least the receiving device-specific reference signal; and
notifying the selected mode to the receiving device.

11. A communication method comprising:
receiving a common reference signal and a receiving device-specific reference signal transmitted from a transmission device; and
reporting a receiving quality to the transmission device using at least the receiving device-specific reference signal.
